(19) United States
(12) Patent Application Publication
(10) Pub. No.: US 2011/0164757 A1
(43) Pub. Date: Jul. 7, 2011

(54) PINNA SIMULATOR

(76) Inventors: Alastair Sibbald, Cookham (GB); Martin Howle, Edinburgh (GB)

(21) Appl. No.: 13/056,897

(22) PCT Filed: Jul. 23, 2009
(86) PCT No.: PCT/GB2009/050915

§ 371 Date: Mar. 22, 2011

(30) Foreign Application Priority Data
Jul. 31, 2008 (GB) 0814048.5

(51) Int. Cl. H04R 29/00

(52) U.S. Cl. 381/58

(57) ABSTRACT

An ear simulator has an inlet port (62), for receiving sounds from a speaker (18) of a communications device such a mobile phone handset (12), and has an outlet port (38) in an opposite surface. The ear simulator has at least one additional aperture (60) in the same surface as the inlet port (62), representing acoustic leakage around a mobile phone held against a user's ear. This allows the ear simulator to provide measurement results that more accurately represent the frequency dependent phase response of the transfer function from the handset loudspeaker driver to the ear of a user of the handset.

This invention relates to an ear simulator, and in particular an ear simulator that can be used in testing a portable sound reproduction device, for example a mobile communications device such as phone, or any other such portable device.

It is known to use an ear simulator in order to make measurements relating to the properties of a telephone handset, or of earphones. The Brüel & Kjaer (B&K) Type 4195 is an ear simulator of this type.

This known ear simulator incorporates a cavity, of a size and a generally cylindrical shape (25 mm in diameter and 9 mm deep; volume approximately 4400 mm³) that is designed to represent the concha cavity of a typical human ear, and an opening against which a telephone handset can be placed. The known ear simulator also incorporates an ear canal extension, terminated by a reference microphone, in order to allow measurements to be made. Two alternative models of the Type 4195 ear simulator are available, one featuring a relatively small (“low”) acoustical leakage from the central cavity to the exterior, extending circumferentially around the cavity and having a total leakage area of approximately 5.4 mm², with a length of about 4.5 mm; and another model featuring a larger (“high”) acoustical leakage from the cavity to the exterior, in the form of an array of thirty-six 1.7 mm diameter holes, approximately 8.5 mm in length, formed in the surface that contains the ear canal extension, the thirty-six holes together having a combined area of about 82 mm².

These known ear simulators allow the user to obtain measurements of the frequency response of a telephone handset or other device, when in use, that are representative of the properties of the handset or device in use in conjunction with a human ear. The aforementioned “high” and “low” acoustical leakage options are intended to represent the leakage pathways in the air around the handset itself that are present when a handset is held loosely or tightly, respectively, against the user's ear.

Such acoustical leakages are characterized by their complex acoustic impedance—analogous to an electrical impedance—which is an entity comprising both reactive and resistive components. In this case, however, the leakages are so physically large that the resistive element is relatively insignificant, and the leakage impedance is dominated by the acoustic mass component of the leakage pathway; it is essentially an acoustic inertance (analogous to an electrical inductance). The acoustic compliance of the leakage is also insignificant. The acoustic mass, M_{A}, that characterises the inertance of the acoustic leakage around a handset (that is, of a volume of air that undergoes non-compressive acceleration) can be calculated from the length, L, and cross sectional area, A, of the leakage pathway, according to the following formula (where ρ₀ is the density of air at STP: 1.18 kg·m⁻³).

$${M}_{A} = \frac{{ρ}_{0} \cdot L}{A} kg . {m}^{4} \qquad ( 1 )$$

It has been suggested to provide noise-cancellation circuitry in telephone handsets, in order to improve the speech intelligibility that can be perceived by the user, that is, the articulation index (for example, Kimura et al., U.S. Pat. No. 5,138,664). The principle is that one (or more) noise microphone is placed on the handset in a position where it can detect external ambient noise, and the signal detected by this microphone is used to generate a further signal that is applied to the speaker of the handset, in order to produce an opposite phase sound that at least partly cancels the ambient noise heard by the listener. Signal-processing circuitry is used to generate the signal that is applied to the speaker from the signal generated by the noise microphone.

The signal-processing that must be carried out depends on the electro-acoustic properties of the handset, when in use, and so it was thought that an ear simulator of the known type would be a useful tool to make the required measurements, in order to allow the required form of the signal-processing to be determined. However, it has been found that the known ear simulator does not provide sufficiently accurate measurements of the required properties of the handset.

Further research has led to the realization that, in order to achieve better levels of noise-cancellation, it is necessary to be able to characterize the electro-acoustic transfer function from the handset loudspeaker driver-to-ear (referred to herein as the “DE” function) not only in terms of its frequency-dependent amplitude response, but also in terms of its frequency-dependent phase response, and therefore that it would be necessary to use an ear simulator that simulates accurately not just the amplitude response of the signals, but also the phase response.

To date, phase responses have not been at all relevant for handset manufacturers, who are primarily concerned with frequency response characteristics, and with the measurement of loudness, noise and distortion.

A second, equally important realization is that, for ambient noise-cancellation, it is required to characterize the acoustic-electric transfer function of the leakage around the handset from the ambient-to-ear (referred to herein as the “AE” function), not only in terms of its frequency-dependent amplitude response, but also in terms of its frequency-dependent phase response. For this, too, it is necessary to have an ear simulator that simulates accurately not just the amplitude response of the AE function, but also its phase response. The phase response is critically dependent on the length and nature of the acoustic pathways involved, and on the associated time-delays.

Consequently, the phase response is critically dependent on the spatial positioning of leakage apertures in the ear simulator. Even small path-length variations can have a large effect on phase response. For example, when a sound wave travels a path length of, say, only 20 mm, in air, the transit time is about 58 μs. This appears to be a very short time period, but at a frequency of 1 kHz, this represents a 21° phase lag. In GB-2,434,708 A, the critical requirement for time-aligning the noise-cancellation signal to that of the incoming acoustic noise signal has been stated and quantified, and it has been shown that, even under optimum conditions (perfect amplitude matching), then phase-alignment of better than 20° is required for even a modest amount of cancellation (−9 dB).

Accordingly, it is an important realization that the acoustic leakage pathways in an ear-simulator that would be suitable for ambient noise-cancellation measurements must be spatially correct, in that they are spatially positioned in locations that are representative of the actual leakage pathway positions associated with the ear of a human user.

According to a first aspect of the invention, there is provided an ear simulator, for testing a communications device that comprises a speaker, the ear simulator comprising:
a casing, defining a cavity, wherein the casing has a first surface with an outlet port therein, and a second surface generally opposed to the first surface with an inlet port therein;
wherein the second surface further contains one or more apertures, exposed when the communications device is in a test position such that the speaker is adjacent to the inlet port.

According to a second aspect of the invention, there is provided a method of calibrating a device, comprising:
playing a first test sound through the device while it is being held by a user in a position representative of normal use;
measuring the sounds detected in a concha cavity of the user;
determining an amount of sound leakage at a concha cavity to device interface;
playing the first test sound through the device while it is being held against an ear simulator having an adjustable leakage area;
adjusting a leakage area of the ear simulator such that it approximates the determined amount of sound leakage;
playing a second test sound through a loudspeaker positioned away from the device, while the device is being held against the ear simulator; and
making measurements of sounds detected while playing the second test sound through the loudspeaker.

For a better understanding of the present invention, and to show how it may be put into effect, reference will now be made, by way of example, to the accompanying drawings, in which:

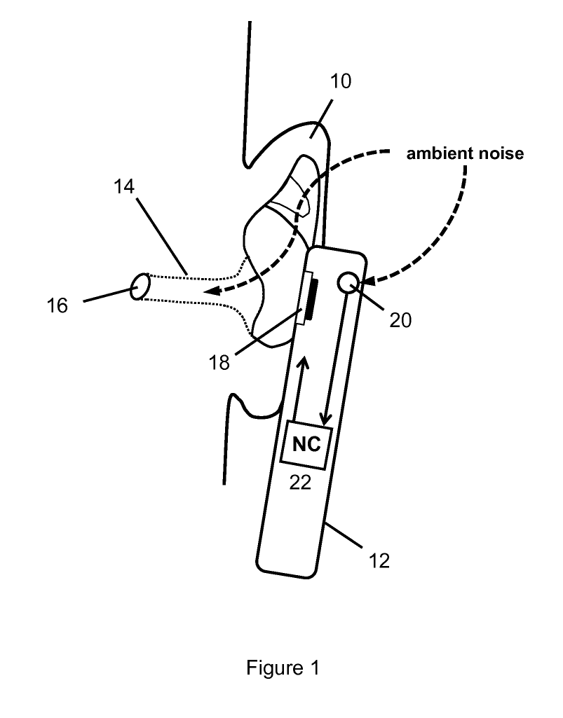

FIG. 1 is a schematic illustration of a telephone handset, featuring ambient noise-cancellation, in use against a human ear;

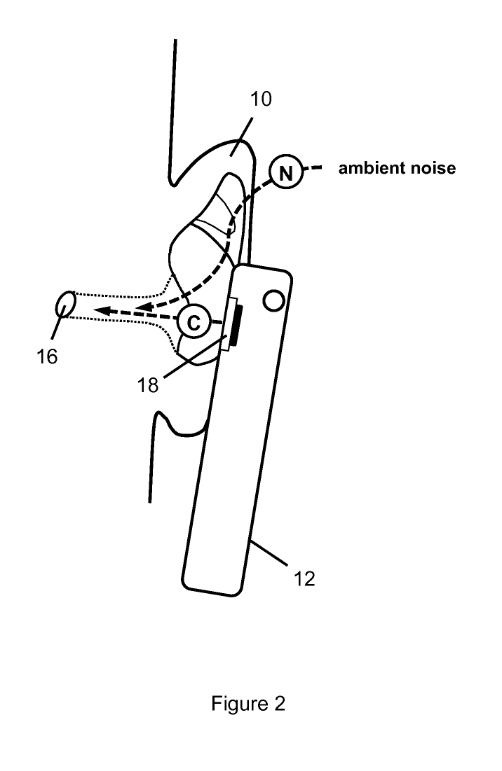

FIG. 2 is an illustration of the acoustic pathways to the eardrum for an ambient noise signal, N, and a noise-cancellation signal, C;

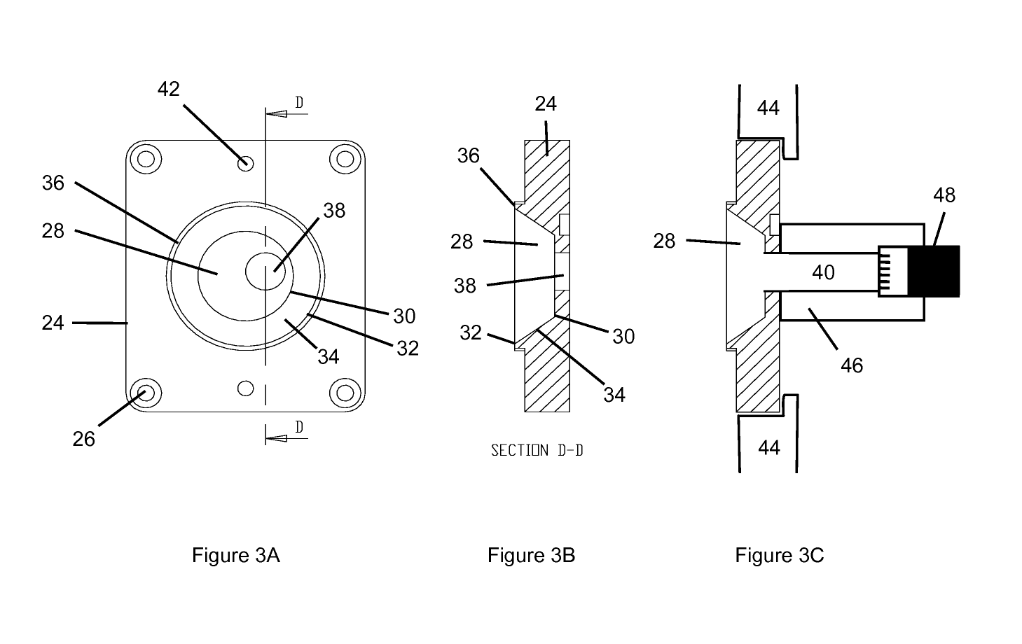

FIG. 3 shows a base-plate unit, featuring concha cavity and ear-canal connector, in accordance with the present invention, in which FIG. 3A is a front elevation view, FIG. 3B is a sectional, end elevation view and FIG. 3C shows the latter mounted on to an ear-canal simulator and mounted into an artificial head;

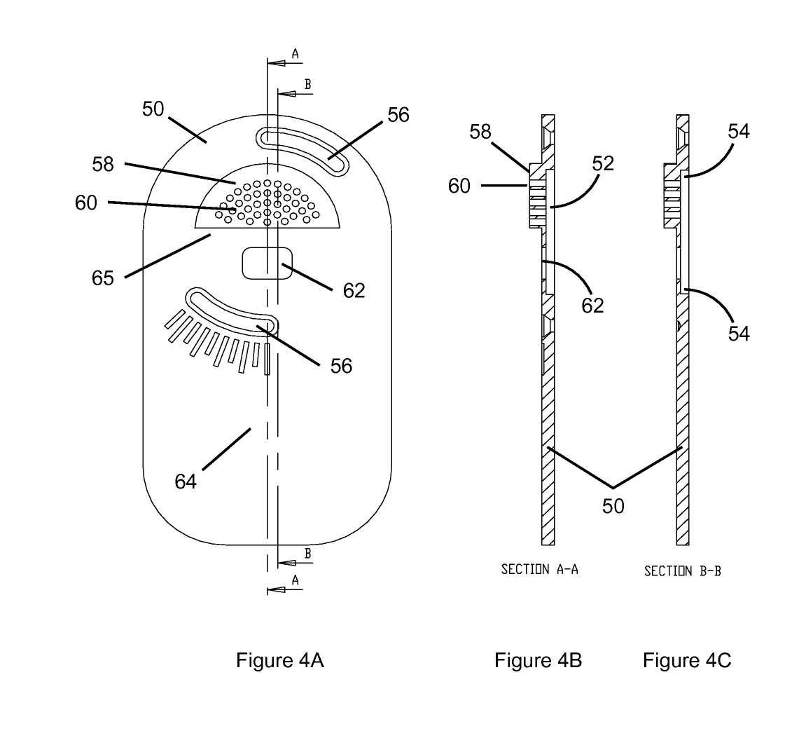

FIG. 4 shows an acoustic leakage plate assembly in accordance with an aspect of the present invention, in which FIG. 4A is front elevation view; and FIGS. 4B and 4C are sectional, end elevation views;

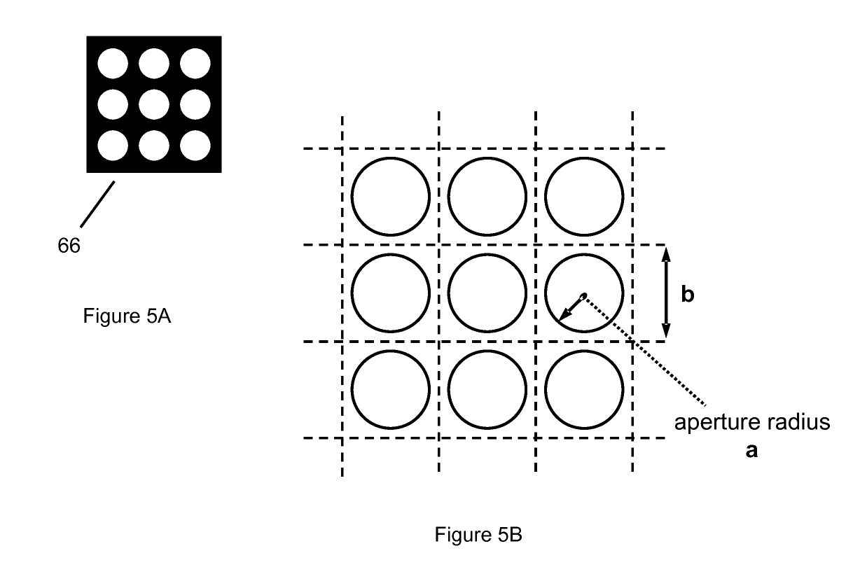

FIG. 5 is a diagram depicting an array of closely spaced acoustic leakage apertures, in which FIG. 5A shows the aperture array; and FIG. 5B indicates the dimensional notation of the array;

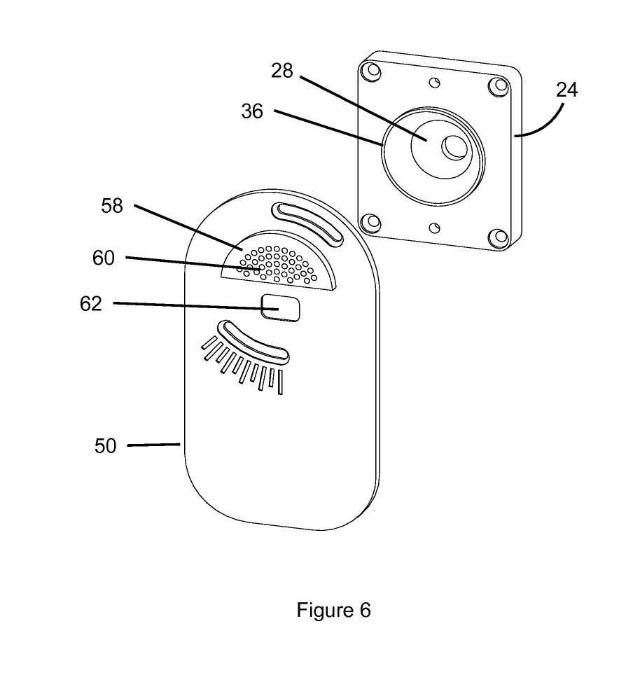

FIG. 6 is an exploded diagram of an acoustic leakage plate assembly and base-plate unit;

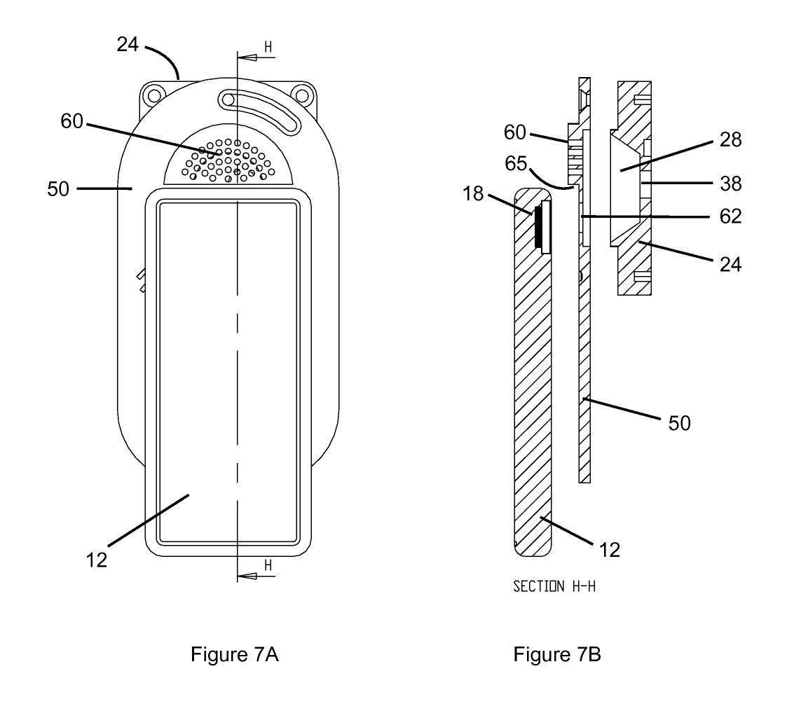

FIG. 7 shows a cellular phone handset located adjacently to an ear-simulator according to an aspect of the present invention, in which FIG. 7A is a front elevation view and FIG. 7B is an exploded, sectional, end elevation view;

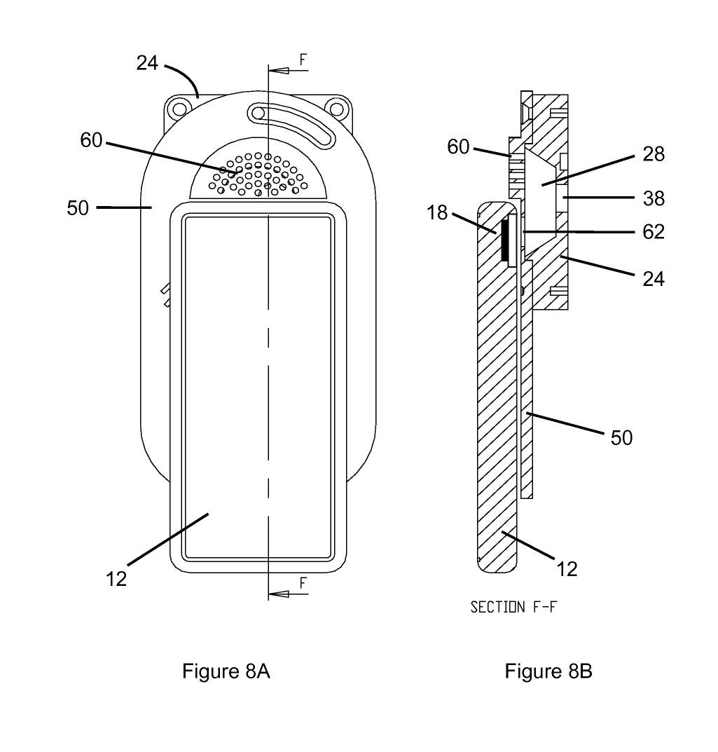

FIG. 8 shows a cellular phone handset located on to an ear-simulator according to an aspect of the present invention, in which FIG. 8A is a front elevation view and FIG. 8B is a sectional, end elevation view;

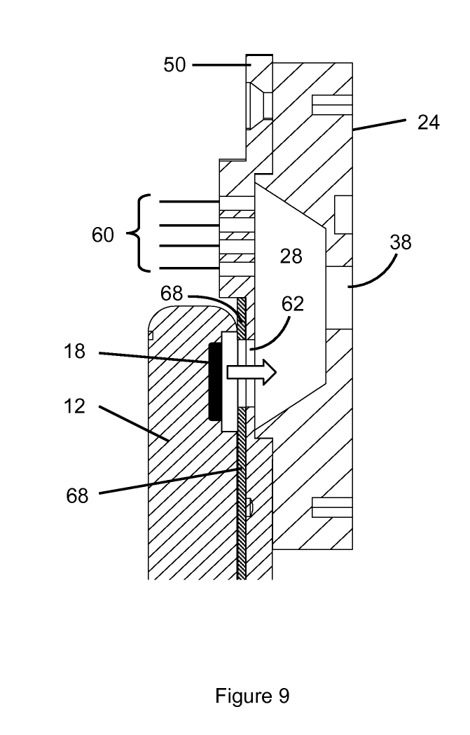

FIG. 9 depicts the detail of a cellular phone handset located onto an ear-simulator according to an aspect of the present invention; and

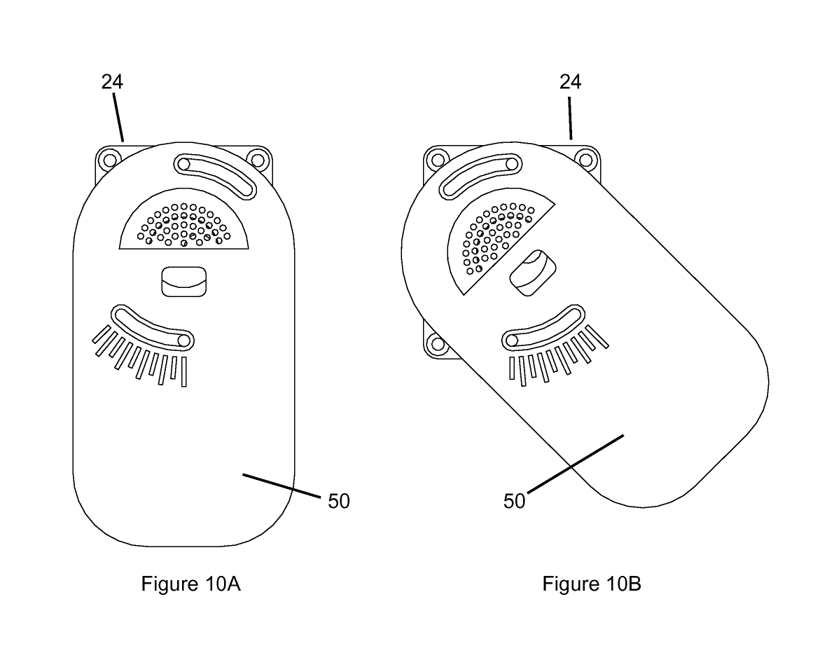

FIG. 10 depicts the rotational capability of an ear-simulator according to the present invention, in which FIG. 10A shows the ear simulator in a first rotational position, and FIG. 10B shows the ear simulator in a second rotational position.

FIG. 1 shows the “pinna” (outer-ear flap) of a human ear 10 with a telephone handset 12 placed against it, as in typical use. The ear canal 14 and eardrum 16 are also shown, and the telephone handset 12 is shown placed by the user, as is typical, such that its speaker 18 directs sound towards the ear canal 14.

The telephone handset 12 is provided with noise-cancellation capabilities, and therefore includes at least one noise microphone 20, positioned such that it can detect ambient noise. The electrical signal representing the ambient noise is passed to noise-cancellation (NC) circuitry 22, which performs appropriate signal-processing on the electrical signal to generate a noise-cancellation signal. This noise-cancellation signal is added to the wanted signal (for example the signal representing the voice of the remote telephone caller, or a signal generated by an application running on the handset), and applied to the speaker 18.

With suitably designed signal-processing, the effect is that the sound generated by the speaker 18 in response to the noise-cancellation signal has the effect of at least partially cancelling the ambient noise that is also reaching the eardrum 16 of the user.

It is known that, in order to achieve a substantial degree of noise-cancellation, the noise-cancellation circuitry must apply a transfer function to the detected noise signal, such that the noise-cancellation sound, generated by the speaker 18 that reaches the eardrum 16 of the user is as nearly as possible equal in magnitude, and opposite in phase, to the ambient noise that reaches the eardrum 16 of the user.

FIG. 2 depicts in general terms the acoustic leakage pathway to the eardrum for the ambient noise signal, N, and also the path to the eardrum for the noise-cancellation signal, C, that is generated by the speaker 18. The ambient noise leakage occurs around the edges of the handset, but a significant portion of this leakage occurs across the top edge of the handset into the ear, where there is gap between the face of the handset and the upper part of the concha cavity.

Moreover, the fact that handsets are generally cuboidal in shape, albeit usually with rounded edges, means that they cannot fit tightly over an ear, and hence that the leakage is usually relatively large, at least when compared with the leakages that are associated with earphones and the like.

It is known that the ambient noise reaching the eardrum 16 of the user is acoustically modified during its progression along the acoustic leakage pathway from the ambient to the eardrum (this frequency dependent modification being referred to herein as the AE transfer function). It is especially modified by the resonant cavity between the handset and the outer ear cavity, and by the nature and positioning of the leakage path. The overall acoustic situation is complex, with reflections from the listener's head and diffraction around the handset also contributing to the various transfer functions. All of these factors should be mimicked as well as possible by the ear simulator (in conjunction with an artificial head system) if accurate and valid transfer function measurements are to be obtained.

In order to define the correct signal-processing transfer function for an ambient noise-cancellation system, then several contributory transfer functions must be characterized, as follows. Firstly, it has already been noted that the noise-cancellation sound at the eardrum that is generated by the speaker 18 (the electro-acoustic driver-to-ear “DE” function) is affected by the properties of the handset and the acoustic path to the eardrum.

The relationship between the acoustic ambient noise signal and the derived electrical signal representing said ambient noise can be expressed as a frequency-dependent transfer function AM (ambient-to-microphone). Meanwhile, as mentioned above, the modification of the ambient noise reaching the eardrum 16 of the user is referred to herein as the AE transfer function.

The optimum value for the signal-processing transfer function, (referred to herein as “SP”), can be derived from the aforementioned functions. Hence, SP is the frequency-dependent transfer function of the signal-processing circuitry, which, for these purposes, can also be taken to include any amplification applied by, and any non-linearity in the transfer function of, any amplifier in the signal path.

In order to achieve effective ambient noise-cancellation, the acoustic noise-cancellation signal should be as nearly as possible equal in magnitude and opposite in phase to the counterpart acoustic ambient noise signal that reaches the eardrum 16 of the user.

Using the transfer functions defined above, this requires that:

AE=AM·SP·DE (2)

Since it is the signal-processing transfer function SP that is the controllable variable in this equation, it can be more useful to express this as:

SP=AE/(AM·DE) (3)

It will therefore be apparent that, in order to achieve effective noise cancellation, it is necessary to take accurate measurements of the transfer functions.

Moreover, it has been appreciated that it is not only the amplitude response, but also the phase response, that plays an equally important part in achieving successful noise-cancellation.

In the context of the present invention, this has led to the realization that, if an ear simulator is to be used for making the measurements on a handset that will be used to determine the required signal-processing transfer function SP, then the ear simulator must impart the required phase characteristics on to the sounds. This means that the leakage between the cavity of the ear simulator and the ambient must represent the true physical situation when a handset is used with a real ear with sufficient accuracy.

One particular embodiment of the present invention comprises two elements, namely a base-plate unit, featuring a concha cavity and ear-canal connector, and also an acoustic leakage plate assembly, featuring acoustic leakage means, acoustic coupling means for a handset, while also allowing rotational positional adjustment, as described in more detail below. These two elements are coupled together and used in conjunction with an ear-canal simulator for making the necessary measurements for deriving effective ambient noise-cancellation signal-processing means for said handset.

FIG. 3 shows the base-plate unit, in which FIG. 3A is a front elevation view, FIG. 3B is a sectional, end elevation view and FIG. 3C shows the base-plate unit mounted on to an ear-canal simulator and fitted into the sidewall of an artificial head assembly.

Referring to FIG. 3A, the base-plate unit 24 is formed from a 60 mm (height) by 50 mm (length) plate, which dimensions are compatible for mounting on to a B&K Type 5930 artificial head, for example using screws via four mounting holes 26, and is manufactured from a rigid material, such as aluminium or hard plastic model board or the like. The base-plate contains a major cavity 28, which is representative of the concha cavity of the human outer-ear. This can be manufactured for example in the form of a cylindrical cavity, or in the form of a truncated conical cavity as shown in FIG. 3.

The cavity 28 is defined by a lower circular surface 30 and an upper circular surface 32 that is parallel to the lower surface, with a circumferential wall 34 extending between them. As will be discussed in more detail below, the leakage is provided at the plane of the upper circular surface 32. In this description, the terms “upper” and “lower” are used to define the orientation of the device, where the “lower” surface 30 being equivalent to the floor surface of the concha cavity of the human ear, and the “upper” surface being enclosed and defined by the rim 36 of the cavity.

The dimensions are chosen so as to provide a volume representative of a concha volume. A typical concha volume is about 4400 mm³, although the cavity 28 may have either a larger or a smaller volume, in accordance with physiological variations. In another example, the cavity 28 may have a volume that is larger than the typical concha (such as 5650 mm³, for example), which is then reduced in use by inserting some acoustically opaque material to reduce the effective volume to a required value.

As described above, the leakage is provided at the plane of the upper circular surface 32, and it is advantageous if the leakage area exceeds a certain minimum size. For the example depicted in these Figures, where the cavity volume is about 3800 mm³, it is problematic to provide the required leakage area in the upper surface of a cylindrical cavity having an appropriate depth, and so the concha cavity 28 is in the form of a truncated conical cavity in which the upper surface is larger than the lower surface. Specifically, in this example, the truncated conical cavity has an uppermost diameter of 30 mm, a lowermost diameter of 19.2 mm, and a depth of 8 mm. Where a larger cavity volume is provided, it may be simplest to provide a cylindrical cavity, as it will still be possible to provide the required leakage area in the upper surface.

In the base of the concha-simulating cavity 28 there is provided an 8 mm diameter aperture 38 defining an outlet port for coupling to an 8 mm diameter ear-canal simulator tube 40. It will be noted that, in order to represent a real ear, this aperture 38 is not provided centrally in the lower surface 30, but rather is located, in this illustrated orientation, to the right of the centre, because the ear canal in a real ear is located towards the front of the ear cavity, and is not centrally located.

Around the upper edge of the cavity 28 there is a 2 mm-wide rim, 36, having an outside diameter of 34 mm, which fits into a complementary 34 mm diameter recess in the acoustic leakage plate unit (which is itself shown in more detail in FIG. 4). In addition, the base-plate unit 24 contains two threaded holes 42 into which locking screws are fitted in order to clamp the acoustic leakage plate on to the base-plate 24. FIG. 3C shows the base-plate unit mounted into the sidewall 44 of an artificial head, and which is coupled to an ear-canal simulator. This comprises a 21 mm long central, metal tube, having 8 mm outside diameter and 7.5 mm inside diameter, representing the dimensions of a typical ear canal, mounted into a plastic housing 46, and terminated by a reference grade microphone 48, such as a B&K Type 4009. Alternative ear canal simulators can be employed with the present invention, including the B&K type 4195 canal simulator. For example, the ear canal extension aperture 38 can readily be modified such that a coupler and a microphone preamplifier, as provided for use with the Brüel & Kjaer Type 4195 ear simulator, can be connected thereto, for example by a screw-fitting.

It will be appreciated that the assembly of FIG. 3C represents an ear-simulator having a concha volume, ear canal volume and measuring microphone, mounted into an artificial head system.

If the cavity 28 were to be cylindrical, as in the case of the Brüel & Kjaer Type 4195 ear simulator, the upper, circular surface 32 might not be large enough to provide both the required leakage area and handset coupling means. Therefore, in this illustrated embodiment, the cavity 28 is in the form of a truncated cone, with the upper circular surface 32 having a larger area than the lower circular surface 30, with the circumferential wall 34 extending outwardly between them with a constant rate of taper moving from the upper surface to the lower surface. In other embodiments, the circumferential wall 34 could be either convex or concave when seen from the outside, that is, with an increasing or decreasing rate of taper moving from the upper surface to the lower surface. In yet a further embodiment, the circumferential wall 34 is stepped, so as to form a composite cylindrical cavity having two or more differing diameters at different heights.

As mentioned above, a predetermined acoustical leakage is formed at the upper surface 32 by the incorporation of a plurality of apertures in the acoustic leakage plate unit, as will be described in the following.

FIGS. 4A, 4B and 4C show an acoustic leakage plate assembly in accordance with an aspect of the present invention, in front elevation (left) and sectional, end elevation views (centre and right), respectively. The leakage plate 50 is, for the most part, 3 mm in thickness. The underside of the plate contains a 34 mm diameter recess 52, that is 2 mm in depth, and which mates with the aforementioned concha rim of the base-plate, the rim edges locating to the recess edges 54. This enables the leakage plate to be rotated around the axis passing orthogonally through the centre of the concha cavity, and there are two countersunk arcuate slots 56 cut into the leakage plate for two locking screws be located, such that relative rotational adjustment of the leakage plate about the base-plate can be made, and then the screws can be tightened to lock the two units together at a required angular disposition.

The upper surface of the leakage plate 50 contains a semi-circular raised area 58, into which an array of acoustic leakage holes 60 are formed. In the example here, there are 37 holes, each 1.7 mm diameter, and their length (that is, the depth of the raised area 58) is 4 mm. Immediately below the semi-circular raised leakage area 58, there is a 12 mm by 8 mm aperture 62 defining an inlet port for forming an acoustical couple with a handset loudspeaker, and there is a large flat area 64 provided, on to which a handset can be securely mounted, face downwards.

The lowermost, flat edge 65 of the raised leakage area 58 provides a “stop” for the handset; that is, a surface against which the uppermost edge of the handset can be abutted such that the handset may be positioned correctly along its length, to allow its properties to be measured, together with the associated ambient-to-ear leakage pathway transfer function. In other embodiments, the positioning device can locate the handset in two or more dimensions. For example, the positioning device can include one or more guides so that a handset is held in the correct lateral position and/or is held against the upper surface 64 with a desired pressure.

As mentioned above, the cavity 28 as shown here has a depth from top to bottom of approximately 8 mm, and a volume of approximately 3800 mm³. As mentioned above, the cavity 28 is provided with an acoustic leakage, and this is preferably provided mostly or entirely at the upper circular surface 32 in order to provide the most realistic simulation of the usage of a handset. In addition, the leakage preferably has an acoustic mass that can be adjusted (by changing the total surface area of the leakage apertures) down to a value of about 60 kg·m⁻⁴. Moreover, a relatively large part of the upper surface 32 is occupied in use by the handset 12.

Referring to the raised surface leakage area 58, when a number of acoustic leakages are formed into a closely spaced array 66 of this type, as shown in FIG. 5, then a slightly different equation is required for the calculation of the acoustic mass (assuming that the acoustic compliance and resistance are negligible) of each of the elements, to take account of end effects. Where the leakage aperture radius is a, the spacing pitch is b, and the length (depth) is t, then the formula is as follows.

$${M}_{A} = \frac{{ρ}_{0}}{π {a}^{2}} [ t + 1.7 a ( 1 - \frac{a}{b} ) ] kg . {m}^{- 4} \qquad ( 4 )$$

Where there is a single leakage aperture of radius a, and length (depth) t, then the formula for the acoustic mass might more accurately be expressed to include end effects as:

$${M}_{A} = \frac{{ρ}_{0}}{π {a}^{2}} [ t + 1.7 a ] kg . {m}^{- 4} \qquad ( 5 )$$

In order to constrain the influence of end effects, it is desirable for each of the leakage apertures to have a length (that is, a depth through the surface of the cavity) that is at least as long as its diameter. Depending on the thickness of the raised area 58, this may mean that it is not possible to have any single aperture that is larger than, say, 4 mm diameter, although it is still possible to have apertures whose individual areas sum to a maximum aperture area, and are such that any desired total aperture area up to the maximum aperture area can be achieved with acceptable accuracy, for example in increments of no more than 3 mm².

The two components of the present invention, the base-plate and the leakage plate, are shown in isometric view in FIG. 6, aligned, but separated for clarity.

FIG. 7 shows how a handset 12 is mounted on to the leakage plate 50 of the present invention, which in turn is mounted and locked on to the base-plate unit. This helps to illustrate how the purpose of the raised semi-circular leakage region is threefold.

Firstly, the height of the raised section 58 above the handset mounting region 64 is 3 mm in this example, and this provides a physical “stop” 65 against which the upper edge of the handset can be abutted, as shown, in order to enable reproducible measurements.

Secondly, the 3 mm height of the raised section 58 is enough to provide a suitable length (depth) for the acoustic leakages which, ideally need to be greater than the diameter of the holes to minimise edge effects. (Here the depth is 4 mm.)

Thirdly, the position of the leakage hole array 60 is truly representative of the position of the acoustic leakage pathway over the edges of a handset in use, and this enables acoustic measurements to be made with great accuracy, especially in respect of phase.

Referring now to the section diagram of FIG. 8B, it will be appreciated that, when the leakage plate 50 is located on to the base-plate 24, and locked to it, and when the handset 12 is located on to the leakage plate 50 (using an elastomeric band, or double-sided adhesive tape), then the loudspeaker 18 of the handset is coupled acoustically via aperture 62 in plate 50 to the concha cavity 28 of the base-plate 24.

Optionally, a suitable, thin, soft and acoustically opaque gasket material 68 (such as a closed cell polyurethane material, for example Poron®) can be used around aperture 62 to ensure a properly sealed joint between the handset and simulator, such that there is no lateral acoustic leakage from the speaker 18 before it enters the cavity 28. This has been omitted from FIG. 8 for clarity, but is shown in greater detail in FIG. 9. The gasket 68 is preferably formed specifically to fit around the aperture 62. In one embodiment of the invention, the surface of the plate 50 surrounding the aperture 62 has a recess formed therein, and the gasket 68 can be located in the recess to ensure that it is correctly positioned to prevent this lateral acoustic leakage.

However, there is a leakage path from the ambient via leakage hole array 60 into the concha cavity simulator 28.

Accordingly, the entire assembly is representative of a handset in use against the ear of a user. Preferably measurements are made with the system mounted on to an artificial head, as described previously (FIG. 3C).

As described above, the surface area of the total effective leakage is controllable. In some embodiments of the invention, this may for example be achieved by providing a single large aperture, and a controllable closure mechanism that can be arranged so that the effective area of the aperture is reduced to a desired value.

Alternatively, in this illustrated embodiment, the amount of acoustic leakage can be controlled by occluding, selectively, one or more of the thirty-seven leakage holes 60, simply using a patch of adhesive tape or similar means. In this example, where the holes are all 1.7 mm in diameter (radius a=0.85 mm) and 4 mm in length, and the spacing pitch (b) is about 2.6 mm, then the acoustic mass of each array element can be calculated using equation (4), to be 2585.1 kg·m⁻⁴, and the acoustic mass of the entire, thirty-seven hole array to be 69.9 kg·m⁻⁴, and hence this defines the operating range of this particular example. Where only one of the leakage holes 60 is left open, then the acoustic mass of the leakage aperture can be calculated using equation (5) to be 2830.1 kg·m⁻⁴.

In comparison with this, the “small” leak of area 5.4 mm² and length 4.5 mm (similar to that of the B&K Type 4195 adaptor “low” leakage, using equation 1, has a value of about 983.3 kg·m⁻⁴. Similarly, the “large” B&K leak area of thirty-six 1.7 mm diameter holes on a 2 mm pitch, assuming a length value of about 8.7 mm, and using equation (4), has a calculated total acoustic mass value of about 137.6 kg·m⁻⁴. Accordingly, the leakage range of the depicted example of the present invention (70 to 2830 kg·m⁻⁴) readily encompasses the magnitudes of the conventionally accepted leakage values in ear simulators.

It will be appreciated that by slackening the locking screws fitted via apertures 56 into threaded holes 42, the leakage plate can be rotated and locked into a different angular position, representative of a user holding the handset at an angle, aligned approximately in line with the ear-to-mouth axis. FIG. 10 shows an example of this, where the ear simulator has been designed for the right-hand side ear position on an artificial head, and where the leakage plate, bearing the handset (not shown), has been rotated anticlockwise through an angle of 45°.

The effect of this is that the speaker 18 of a handset positioned against the stop 65 is located nearer to the aperture 38 in the base of the cavity. Once more, this allows the real use of the handset to be represented relatively accurately, and therefore enables accurate phase data to be obtained for generating effective noise-cancellation signal-processing algorithms.

Artificial ear simulators of this type, being terminated with a conventional microphone, do not have the natural damping that an ear-drum-terminated ear canal possesses, and therefore are slightly more resonant in nature. In order to overcome this slight difference and provide more a more truthful simulation, adequate damping can be provided by part filling the concha cavity 28 (and optionally the ear canal element 40) with a lightweight, open-cell, polyurethane foam or similar, having, typically, a density of 30 kg·m⁻³.

In another embodiment, the concha volume can be adjusted by including a volume-reducing component, such as a large diameter set screw, into the base or sidewall of the concha volume 28 such that when it is flush with the wall of the cavity, it has no effect, but when it is screwed out, it occupies some of the internal space, thus reducing the volume of air in the cavity. Alternatively, the effective volume of the cavity can be reduced by inserting some acoustically opaque material into the cavity.

The amount of acoustic leakage between the handset-to-concha cavity and the ambient is dependent largely on: (a) the orientation of the handset with respect to the ear of the user; (b) the force that the user exerts against the handset (and ear); (c) the shape and pliability of the surface of the user's pinna; and (d) the surface topography of the handset itself, including the relative positioning of its loudspeaker, because this influences how the user positions the handset and supports it. In order to devise an accurate representation of the acoustic leakage for any particular handset, or to quantify an average leakage value for a group, it is possible to “calibrate” the ear-simulator against one or more individual users, as follows.

Firstly, the user holds the handset against their ear, as would be representative of normal use, and a miniature probe microphone is mounted into the concha cavity of the user, between the ear-canal entrance and the face of the handset. Then, the user is instructed to hold the handset in the position that they would hold it if they were attempting to listen to a real conversation, or the like. This enables the frequency response of the driver-to-ear (concha cavity) transfer function to be measured, by driving the handset's loudspeaker with a known analytical waveform (such as a swept sine-wave, or stretched impulse or similar). This measured frequency response is very dependent on the amount of leakage associated with that handset, and will vary from one handset to another, based on factors such as the size and shape of the handset, and the position of the speaker on the front surface of the handset. It will be appreciated that more widely representative results can perhaps be obtained by performing this procedure with multiple users.

Next, this same measurement is repeated, that is, the handset's loudspeaker is driven with the known analytical waveform, using the ear-simulator in place of an individual's ear, and the response reveals whether the leakage value of the simulator was similar to the human value, or whether it was too high or too low. Accordingly, the total leakage aperture area 60 of the ear simulator is adjusted, for example by sealing some of the apertures, so that the leakage corresponds to the leakage associated with that handset. Then, the measurement and adjustment cycle is repeated until the leakage value of the simulator is made similar to that of the human data.

In addition, the volume 28 of the concha cavity can be adjusted such that the resonant peak of the ear simulator response (at about 2.9 kHz) matches that of the user accurately, and also the magnitude of said resonant peak (related to its Q-factor) can be matched by damping the ear-simulator concha cavity with open-cell foam material, as described. This allows the ear simulator to be adjusted to match any measured human characteristics very precisely.

Once this has been carried out, the critical ambient-to-ear transfer function measurement (the frequency-dependent amplitude and phase responses) can be made by placing the handset on the ear simulator, as shown in FIGS. 8 and 9, driving an externally located loudspeaker with a known analytical waveform, and measuring the ambient-to-ear response via the ear-canal microphone 48. The test waveform used in this step may be the same as the test waveform used in the first two steps, or may be different.

There is thus provided an ear simulator that can be used to make measurements that can be used for characterizing a cellular phone handset for the purposes of providing noise-cancellation.

It will be clear to those skilled in the art that the implementation may take one of several forms, and the intention of the invention is to cover all these different forms.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single unit may fulfil the functions of several units recited in the claims. Any reference signs in the claims shall not be construed so as to limit their scope.

1. An ear simulator, for testing a communications device that comprises a speaker, the ear simulator comprising:
a casing, defining a cavity, wherein the casing has a first surface with an outlet port therein, and a second surface generally opposed to the first surface with an inlet port therein;
wherein the second surface further contains one or more apertures, exposed when the communications device is in a test position such that the speaker is adjacent to the inlet port.

2. An ear simulator as claimed in claim 1, wherein the second surface has a raised portion in the form of a stop guide, for defining the test position for the communications device against the second surface.

3. An ear simulator as claimed in claim 2, wherein the one or more apertures extends through the raised portion of the second surface.

4. An ear simulator as claimed claim 1, having a total aperture area that is controllable, up to a maximum aperture area of at least 80 mm².

5. An ear simulator as claimed in claim 4, wherein the total aperture area is controllable up to a maximum aperture area of at least 90 mm².

6. An ear simulator as claimed in claim 5, wherein the total aperture area is controllable up to a maximum aperture area of at least 100 mm².

7. An ear simulator as claimed in claim 1, comprising a plurality of apertures, wherein the total aperture area is controllable by sealing one or more of said apertures.

8. An ear simulator as claimed in claim 7, wherein each of said apertures has a depth that is greater than its diameter.

9. An ear simulator as claimed in claim 1 wherein the total aperture area is controllable such that any total aperture area, up to the maximum aperture area, can be obtained, in increments of no more than 3 mm².

10. An ear simulator as claimed in claim 1, wherein the stop guide is positioned on the second surface such that a typical handset can be placed on the second surface with its upper edge against the stop guide, and with its speaker adjacent said inlet port.

11. An ear simulator as claimed in claim 10, comprising an acoustically opaque gasket located around the inlet port.

12. An ear simulator as claimed in claim 11, wherein the gasket is made of a closed cell polyurethane material.

13. An ear simulator as claimed in claim 1, wherein the outlet port is located eccentrically in the first surface.

14. An ear simulator as claimed in claim 13, wherein the inlet port is located substantially opposite the outlet port, and wherein the stop guide is positioned on the second surface such that a typical handset can be placed on the second surface with its upper edge against the stop guide, with its speaker adjacent said inlet port, and further comprising an acoustically opaque gasket located around the inlet port, the gasket being made of a closed cell polyurethane material.

15. An ear simulator as claimed in claim 1, wherein the first surface is circular.

16. An ear simulator as claimed in claim 1, wherein the second surface is circular.

17. An ear simulator as claimed in claim 1, wherein the second surface is parallel to the first surface.

18. An ear simulator as claimed in claim 1, wherein the second surface is larger than the first surface.

19. An ear simulator as claimed in claim 18, wherein the cavity is in the form of a truncated cone.

20. An ear simulator as claimed in claim 1, comprising foam damping material within the cavity.

21. An ear simulator as claimed in claim 1, comprising:
a baseplate; and
a leakage plate, wherein the baseplate and the leakage plate can be fixed against each other, such that the baseplate forms the first surface of the cavity, and the leakage plate forms the second surface of the cavity.

22. An ear simulator as claimed in claim 21, wherein the baseplate and the leakage plate can be rotated relative to each other, and can be fixed against each other in a desired relative rotational orientation.

23. A method of calibrating a device, comprising:
playing a first test sound through the device while it is being held by a user in a position representative of normal use;
measuring the sounds detected in a concha cavity of the user;
determining an amount of sound leakage at a concha cavity to device interface;
playing the first test sound through the device while it is being held against an ear simulator having an adjustable leakage area;
adjusting a leakage area of the ear simulator such that it approximates the determined amount of sound leakage;
playing a second test sound through a loudspeaker positioned away from the device, while the device is being held against the ear simulator; and
making measurements of sounds detected while playing the second test sound through the loudspeaker.

24. A method as claimed in claim 23, wherein the step of making measurements of sounds detected while playing the second test sound through the loudspeaker comprises measuring a frequency dependent ambient-to-ear transfer function.

25. A method as claimed in claim 23, wherein the step of measuring the sounds detected in the concha cavity of the user while playing the first test sound through the device comprises measuring a frequency dependent driver-to-ear transfer function.
